(19) United States
(12) Patent Application Publication
(10) Pub. No.: US 2018/0188718 A1
(43) Pub. Date: Jul. 5, 2018

(54) SIMULATION APPARATUS AND COMPUTER READABLE MEDIUM

(71) Applicant: MITSUBISHI ELECTRIC CORPORATION, Tokyo (JP)

(72) Inventor: Takashi SAKAKURA, Tokyo (JP)

(73) Assignee: MITSUBISHI ELECTRIC CORPORATION, Tokyo (JP)

(21) Appl. No.: 15/740,677

(22) PCT Filed: Sep. 2, 2015
(86) PCT No.: PCT/JP2015/074998

§ 371 Date: Dec. 28, 2017

(51) Int. Cl. G05B 19/418; G05B 19/408

(52) U.S. Cl. CPC G05B 19/41885; G05B 2219/36071; G05B 19/4083

(57) ABSTRACT

A simulation apparatus (10) calculates, as an appropriate value, a sensor value at which productivity increases, from a sensor value detected with a sensor disposed in an automation system (20) and productivity of the automation system (20) at a time when the sensor value is detected. While sequentially changing setting, the simulation apparatus (10) executes a simulation of an operation of the automation system (20) and calculates a predicted value of the sensor value for each setting. The simulation apparatus (10) identifies the setting in a case where the predicted value is close to the appropriate value.

### TECHNICAL FIELD

The present invention relates to a simulation technology of an automation system.

### BACKGROUND ART

In recent years, attempts have been made to improve efficiency of production activity by introducing an information communication technology.

For example, a Manufacturing Execution System (MES) planning to execute production and Product Life cycle Management (PLM) enabling sharing of design information have been introduced. Further, a simulation apparatus that verifies products and manufacturing facilities has also been introduced.

Some of simulation apparatuses that verify the manufacturing facilities have been commercialized. The simulation apparatus performs a simulation of manufacturing control such as operation timing of various controllers with input/output devices controlled by the various controllers.

Patent Literature 1 describes that a construction process is simulated using a virtual machine.

### CITATION LIST

### Non-Patent Literature

Patent Literature 1: JP 2014-522529 A

### SUMMARY OF INVENTION

### Technical Problem

Conventionally, the manufacturing facilities are built after verification by the simulation apparatus. Then, if it is confirmed that a verification result by the simulation apparatus is valid in the built manufacturing facilities, the role of the simulation apparatus will end once.

Thereafter, in a case where a substitute product is used due to a change in product specifications or a failure of a device of the manufacturing facilities, the verification is performed again by the simulation apparatus.

In an automation system that requires high precision such as an automation system that manufactures semiconductors, productivity is influenced by factors such as temperature and vibration that do not appear in the simulation of manufacturing control. The present invention aims to enable a simulation in consideration of influence of factors such as temperature and vibration that do not appear in the simulation of manufacturing control, thereby improving the productivity.

### Solution to Problem

A simulation apparatus according to the present invention includes:

an appropriate value calculation unit to perform machine learning from a sensor value detected with a sensor disposed in an automation system and productivity of the automation system at a time when the sensor value is detected, and calculate a sensor value at which the productivity increases, as an appropriate value;

a simulation unit to, while sequentially changing setting, execute a simulation of an operation of the automation system, and calculate a predicted value of the sensor value for each setting; and

a setting identifying unit to identify the setting in a case where the predicted value calculated by the simulation unit is close to the appropriate value calculated by the appropriate value calculation unit.

### Advantageous Effects of Invention

In the present invention, a sensor value at which productivity increases is calculated from a sensor value detected with a sensor disposed in an automation system, and setting of the automation system, in which a value close to the sensor value at which the productivity increases can be obtained, is identified by executing a simulation. By doing this, it is possible to improve the productivity of the automation system.

### BRIEF DESCRIPTION OF DRAWINGS

FIG. 1 is a configuration diagram of a simulation system 100 according to a first embodiment.

FIG. 2 is a configuration diagram of an etching apparatus 201 constituting an automation system 20.

FIG. 3 is a configuration diagram of a simulation apparatus 10 according to the first embodiment.

FIG. 4 is a flowchart illustrating an operation of the simulation apparatus 10 according to the first embodiment.

FIG. 5 is a diagram illustrating a hardware configuration example of the simulation apparatus 10 according to the first embodiment.

### DESCRIPTION OF EMBODIMENTS

### First Embodiment

### Description of Configuration

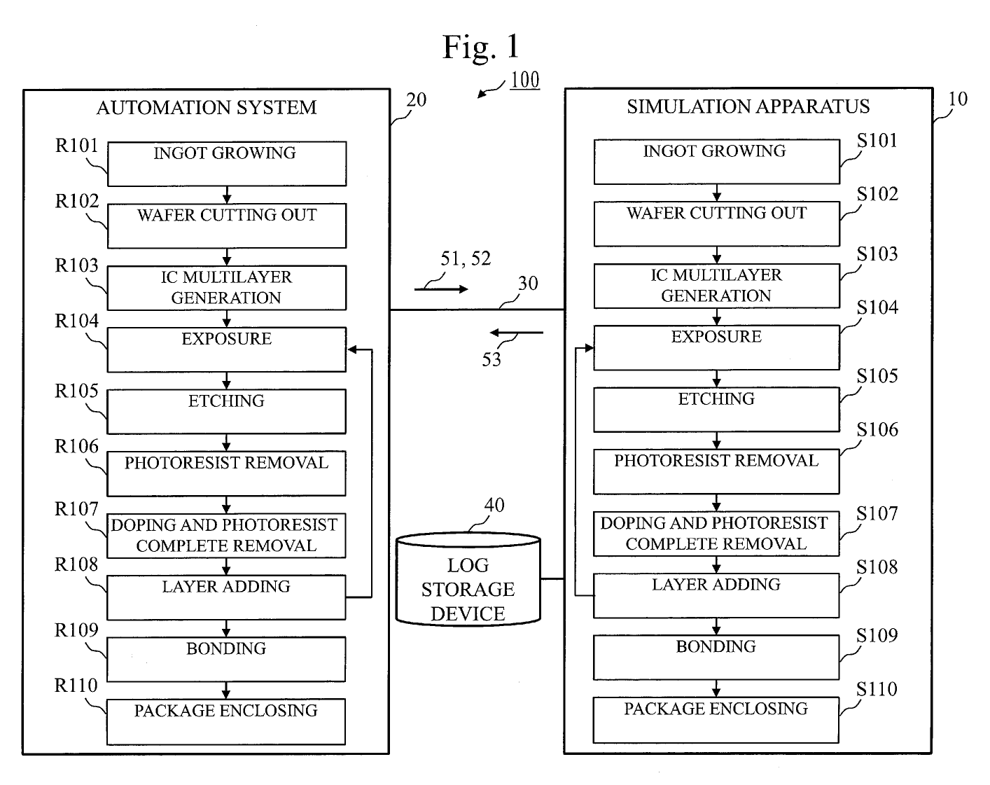

FIG. 1 is a configuration diagram of a simulation system 100 according to the first embodiment.

The simulation system 100 is provided with a simulation apparatus 10 and an automation system 20 already installed and operating. The simulation apparatus 10 and the automation system 20 are connected with each other via a network 30.

The automation system 20 is a factory automation system (FA system) of a semiconductor factory being manufacturing facilities in which high accuracy is required herein. Since the high accuracy is required in the automation system 20, productivity is influenced by external factors of the manufacturing facilities, that is, factors such as temperature, vibration, dust, Electro-Magnetic Interference (EMI), a physical property of a workpiece that do not appear in manufacturing control. In the first embodiment, the productivity means a yield rate.

Note that it is assumed herein that the automation system 20 is the system of the semiconductor factory, but may be another system as long as the automation system 20 is a system whose productivity is influenced by the external factors of the manufacturing facilities.

The automation system 20 manufactures semiconductors by executing an ingot growing step of R101, a wafer cutting out step of R102, an Integrated Circuit (IC) multilayer generation step of R103, an exposure step of R104, an etching step of R105, a photoresist removal step of R106, a doping and photoresist complete removal step of R107, a layer such as aluminum wiring adding step of R108, a bonding step of R109, and a package enclosing step of R110. Note that the steps from R104 to R108 are repeatedly executed as needed.

The simulation apparatus 10 executes steps of S101 to S110 simulating the respective steps of R101 to R110 executed by the automation system 20, thereby simulating an operation of the automation system 20.

The simulation apparatus 10 accurately reproduces by a virtual machine, a device and a program constituting the automation system 20 including a controller constituting the automation system 20, a control program of the controller, and various devices such as a fieldbus, a sensor, and an actuator. Then, the simulation apparatus 10 accurately simulates by the virtual machine, the behavior of each of the steps of R101 to R110 as S101 to S110. The simulation apparatus 10 stores in a log storage device 40, all of events such as execution of machine language by the controller and state changes of various devices that occurred in S101 to S110.

The simulation apparatus 10 receives from the automation system 20, sensor data 51 indicating a sensor value detected with a sensor disposed in the automation system 20 in operation, via the network 30. The sensor value is a value indicating information on the outside of the manufacturing facilities such as temperature, vibration, dust, EMI, and a physical property of a workpiece that do not appear in manufacturing control. Further, the simulation apparatus 10 receives from the automation system 20, productivity data 52 indicating the productivity of the automation system 20, via the network 30.

The simulation apparatus 10 executes a simulation based on the sensor value indicated in the sensor data 51 and the productivity indicated in the productivity data 52, and identifies appropriate setting of the automation system 20. Appropriate means that the productivity of the automation system 20 is increased. The setting is a value of a parameter given to the automation system 20, a logic used in the automation system 20, an arrangement of devices constituting the automation system 20, and the like.

The simulation apparatus 10 transmits setting data 53 indicating the identified setting to the automation system 20. Then, the setting indicated in the setting data 53 is reflected in the automation system 20. Note that the arrangement of devices is manually reflected separately.

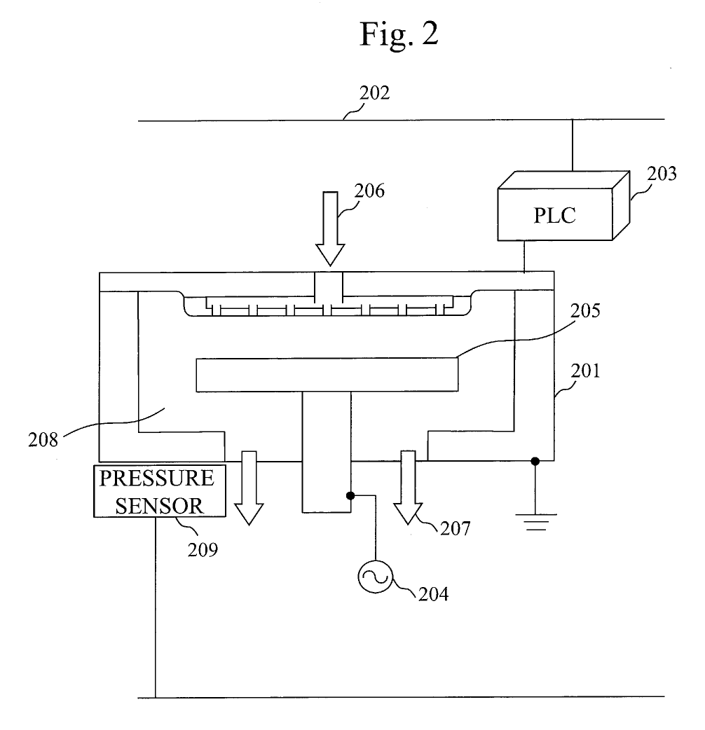

FIG. 2 is a configuration diagram of an etching apparatus 201 constituting the automation system 20.

The etching apparatus 201 is an apparatus for executing the etching step of R105. The etching apparatus 201 is controlled by a PLC 203 connected to a control fieldbus 202 to which a control signal is transmitted. With a configuration illustrated in FIG. 2, the simulation apparatus 10 simulates operations of the control fieldbus 202 and the PLC 203.

While a work surface 205 is rotated by a rotation control device 204, the etching apparatus 201 sprays an etching solution 206 in the form of mist on the work surface 205. At this time, in order to spray the etching solution 206 on all over the work surface 205, the etching apparatus 201 reduces pressure in an inner space 208 of the etching apparatus 201 by a pump 207.

The etching apparatus 201 detects by a pressure sensor 209, the pressure in the inner space 208 at a time when spraying the etching solution 206 on the work surface 205. Then, the etching apparatus 201 periodically outputs pressure data indicating the detected pressure, via a sensor network 210. The output pressure data is transmitted to the simulation apparatus 10 as the sensor data 51 indicating the pressure as the sensor value, via the network 30.

As described above, the pressure in the inner space 208 is controlled by the pump 207. Therefore, it is possible to control the pressure in the inner space 208 by changing a parameter that controls the pump 207.

Similarly, another device constituting the automation system 20 periodically outputs data indicating the sensor value detected with the sensor. Then, the output data is transmitted to the simulation apparatus 10 as the sensor data 51, via the network 30. The sensor data 51 is transmitted to the simulation apparatus 10, the sensor data 51 indicating temperature of a healing furnace forming an oxide film on a wafer; dust, temperature, and humidity in a clean room; and the like as the sensor value herein.

As well as the pressure in the inner space 208 can be controlled by the parameter of the pump 207, the sensor value indicating the data output from another device can be controlled by the setting.

The simulation apparatus 10 receives the sensor data 51 and also receives the productivity data 52 indicating the productivity at a time when the sensor value indicated in the sensor data is detected. The simulation apparatus 10 calculates by machine learning, the sensor value at which the productivity increases, as an appropriate value. Then, the simulation apparatus 10 executes the simulation and identifies the setting in which the sensor value is close to the appropriate value.

If it is a case of the etching apparatus 201 illustrated in FIG. 2, the simulation apparatus 10 identifies the parameter relating to the control of the pump 207 where the pressure is close to the appropriate value.

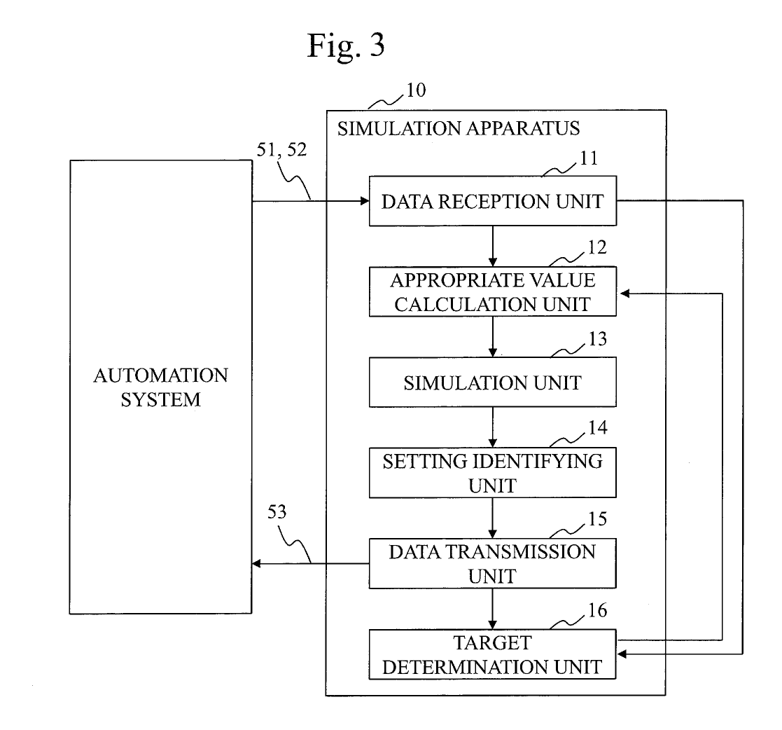

FIG. 3 is a configuration diagram of the simulation apparatus 10 according to the first embodiment.

The simulation apparatus 10 is provided with a data reception unit 11, an appropriate value calculation unit 12, a simulation unit 13, a setting identifying unit 14, a data transmission unit 15, and a target determination unit 16.

The data reception unit 11 receives from the automation system 20, the sensor data 51 indicating the sensor value detected with the sensor disposed in the automation system 20 and the productivity data 52 indicating the productivity of the automation system 20 at the time when the sensor value is detected.

While the automation system 20 is in operation, the data reception unit 11 sequentially receives a pair of the sensor data 51 and the productivity data 52 periodically transmitted from the automation system 20 and accumulates the received pair in a storage device. At this time, the data reception unit 11 accumulates, in the storage device, the setting of the automation system 20 at the time when the sensor value is detected, in association with the pair of the sensor data 51 and the productivity data 52.

The appropriate value calculation unit 12 performs the machine learning from a plurality of pairs of the sensor value and the productivity accumulated in the storage device sequentially received by the data reception unit 11, and calculates the sensor value at which the productivity increases, as the appropriate value.

While sequentially changing the setting, the simulation unit 13 executes the simulation of the operation of the automation system 20 and calculates a predicted value of the sensor value for each setting.

The setting identifying unit 14 identifies the setting in a case where the predicted value calculated by the simulation unit 13 is close to the appropriate value calculated by the appropriate value calculation unit 12.

The data transmission unit 15 transmits to the automation system 20, the setting data 53 indicating the setting identified by the setting identifying unit 14. By doing this, the setting indicated in the setting data 53 is reflected in the automation system 20.

After a certain period of time has elapsed from transmission of the setting data 53 by the data transmission unit 15, the target determination unit 16 determines whether or not the productivity indicated in the productivity data 52 received by the data reception unit 11 is higher than a target value. The target value is a value determined by an executor of the simulation depending on a type of the automation system 20 and the like. By doing this, the target determination unit 16 determines whether or not the productivity of the automation system 20 has become higher than the target value in a case where the automation system 20 is operated using the setting identified by the setting identifying unit 14.

A method of calculating the appropriate value by the appropriate value calculation unit 12 will be described.

The appropriate value calculation unit 12 performs the machine learning using multivariate linear regression herein. The appropriate value calculation unit 12 may use another method known as a method of machine learning.

Assume that the data reception unit 11 receives n types of pairs of the sensor data 51 and the productivity data 52 at each reception timing. Therefore, a set x of sensor values indicated in the sensor data 51 to be received is x:=(x₁, . . . , xₙ). Then, a set θ of appropriate values is θ:=(θ₁, . . . , θₙ). For convenience of calculation, an element x₀ is added to the set x, an element θ₀ is added to the set θ, and let x:=(x₀, x₁, . . . , xₙ)ϵRⁿ⁺¹, θ:=(θ₀,θ₁, . . . , θₙ) ϵRⁿ⁺¹, and θ₀x₀=1 herein. R represents a real number, and n+1 indicated as a superscript on R represents the number of elements.

At this time, a prediction formula h_{θ}(x) of the multivariate linear regression is as shown in Formula 1.

h_{θ}(x)=θ₀x₀+θ₁x₁+ . . . +θₙxₙ [Formula 1]

Let i be a variable representing the reception timing. Let a set x⁽ⁱ⁾ is a set of sensor values indicated in the sensor data 51 received at the reception timing i, and productivity y⁽ⁱ⁾ is productivity indicated in the productivity data 52 received at the reception timing i.

At this time, a cost function J(θ) in the multivariate linear regression is as shown in Formula 2.

$$J ( θ ) = \frac{1}{2 m} {\sum }_{i = 1}^{m} {( {h}_{θ} ( {x}^{( i )} ) - {y}^{( i )} )}^{2} \qquad [ Formula 2 ]$$

In Formula 2, m represents the number of reception timing.

Then, the appropriate value calculation unit 12 calculates the set θ of appropriate values using an algorithm shown in Formula 3.

$$while not converged \{ \\ for all j \\ tmp j := {θ}_{j} - α \frac{\partial }{\partial {θ}_{j}} J ( θ ) \\ \} \qquad [ Formula 3 ]$$

In Formula 3, “:=” represents assignment. α is a coefficient pertaining to a monotonous decrease.

That is, the appropriate value calculation unit 12 calculates tmpⱼ from m number of new pairs of the sensor value and the productivity until values of all elements θⱼ of the set θ of appropriate values converge, and repeats a process of updating the set θ.

In this regard, in order to equalize weight of each type of sensor values, the appropriate value calculation unit 12 adjusts each sensor value xₖ where k=1, . . . , n such that −1≤xₖ≤1. Note that each sensor value xₖ may not be necessarily within the above range as long as each sensor value xₖ does not largely deviate from the above range. It is assumed herein that one or some sensor values xₖ are within −10≤xₖ≤10.

If a value of the cost function J(θ) monotonically decreases in chronological order, the cost function J(θ) can be regarded as functioning correctly.

Note that an initial value of the set θ of appropriate values may be arbitrarily determined. The initial value of the set θ of appropriate values may be a value calculated as the appropriate value in another automation system.

### Description of Operation

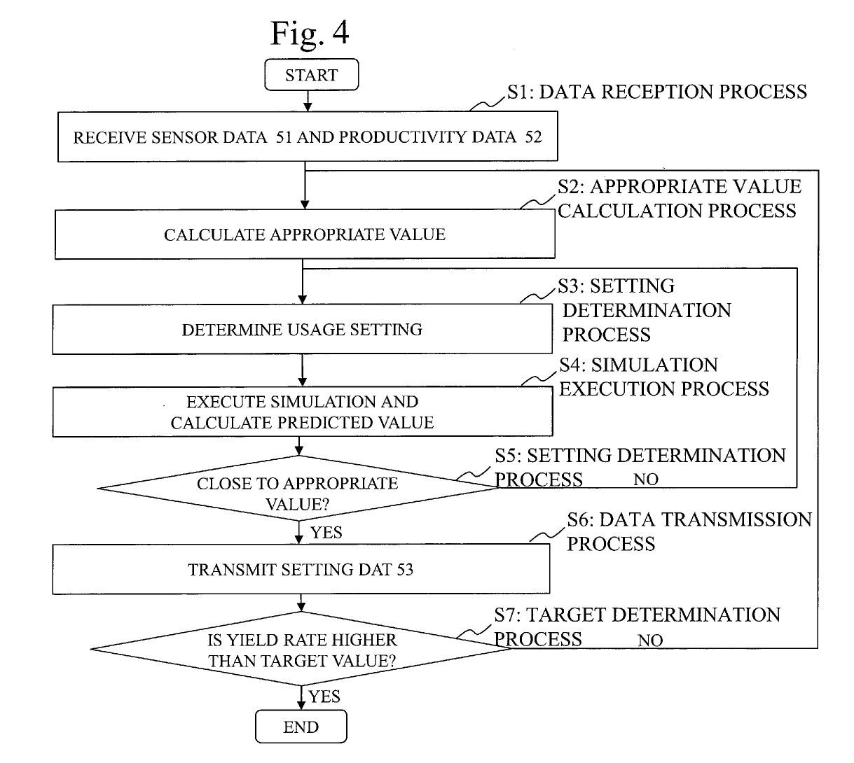

FIG. 4 is a flowchart illustrating an operation of the simulation apparatus 10 according to the first embodiment.

The operation of the simulation apparatus 10 according to the first embodiment corresponds to a simulation method according to the first embodiment. Further, the operation of the simulation apparatus 10 according to the first embodiment corresponds to a process of a simulation program according to the first embodiment.

In a data reception process of S1, while the automation system 20 is in operation, the data reception unit 11 sequentially receives the pair of the sensor data 51 and the productivity data 52 periodically transmitted from the automation system 20, and accumulates the received pair in the storage device.

In an appropriate value calculation process of S2, the appropriate value calculation unit 12 performs the machine learning from the plurality of pairs of the sensor value and the productivity accumulated in the storage device in S1, and calculates the sensor value at which the productivity increases, as the appropriate value.

In a setting determination process of S3, the simulation unit 13 determines the setting to be used for the simulation, as usage setting. At this time, the simulation unit 13 determines from a relationship between the sensor value and the setting accumulated in the storage device, the setting in which the sensor value close to the appropriate value calculated in S2 is estimated to be obtainable, as the usage setting.

In a simulation execution process of S4, the simulation unit 13 executes the simulation of the operation of the automation system 20 using the usage setting determined in S3 and calculates the predicted value of the sensor value for each setting.

In a setting determination process of S5, the setting identifying unit 14 determines whether or not the predicted value calculated in S4 is within before and after a reference range of the appropriate value calculated in S2, that is, determines whether or not the predicted value is close to the appropriate value.

If the predicted value is not close to the appropriate value (NO in S5), the setting identifying unit 14 returns the process to S3 and changes the usage setting. On the other hand, if the predicted value is close to the appropriate value (YES in S5), the setting identifying unit 14 proceeds the process to S6.

In a data transmission process of S6, the data transmission unit 15 transmits to the automation system 20, the setting data 53 indicating the usage setting in a case where it is determined in S5 that the predicted value is close to the appropriate value.

In a target determination process of S7, after the certain period of time has elapsed from the transmission of the setting data 53 in S6, the target determination unit 16 determines whether or not the productivity indicated in the productivity data 52 received by the data reception unit 11 is higher than the target value.

If the productivity is less than or equal to the target value (NO in S7), the target determination unit 16 returns the process to S2 and causes the appropriate value to be recalculated. On the other hand, if the productivity is higher than the target value (YES in S7), the target determination unit 16 ends the process.

In S1, the pair of the sensor data 51 and the productivity data 52 is sequentially received and accumulated in the storage device. Therefore, if the process is returned from S7 to S2 and the appropriate value is recalculated, the usable pair of the sensor data 51 and the productivity data 52 has increased so that more accurate appropriate value is calculated.

However, the productivity may not be improved even if the process is simply returned from S7 to S2.

And so, when the process is returned from S7 to S2, a position of the sensor disposed in the automation system 20 may be changed. By doing this, the appropriate value can be recalculated from the sensor value detected with the sensor disposed at a different position of the automation system 20 and the productivity of the automation system 20 at the time when the sensor value is detected.

Further, when the process is returned from S7 to S2, a simulation logic executed by the simulation unit 13 may be changed. By doing this, the simulation of the operation of the automation system 20 can be executed using another simulation logic, and the predicted value of the sensor value for each setting can be recalculated.

For example, it is possible to verify whether or not the simulation is appropriate by referring to logs of the events accumulated in the log storage device 40. Then, it is possible to change the simulation logic based on a verified result. Further, by repeatedly changing the setting and acquiring the sensor value for each setting, it is possible to construct the simulation logic in which the relationship between the setting and the sensor value is more accurately simulated.

### Effect of First Embodiment

As described above, the simulation apparatus 10 according to the first embodiment obtains the appropriate sensor value by the machine leaning, from the sensor value and the productivity of the automation system 20 in operation, thereby determining the setting of the automation system 20.

By doing this, it is possible to gradually improve the productivity of the automation system 20.

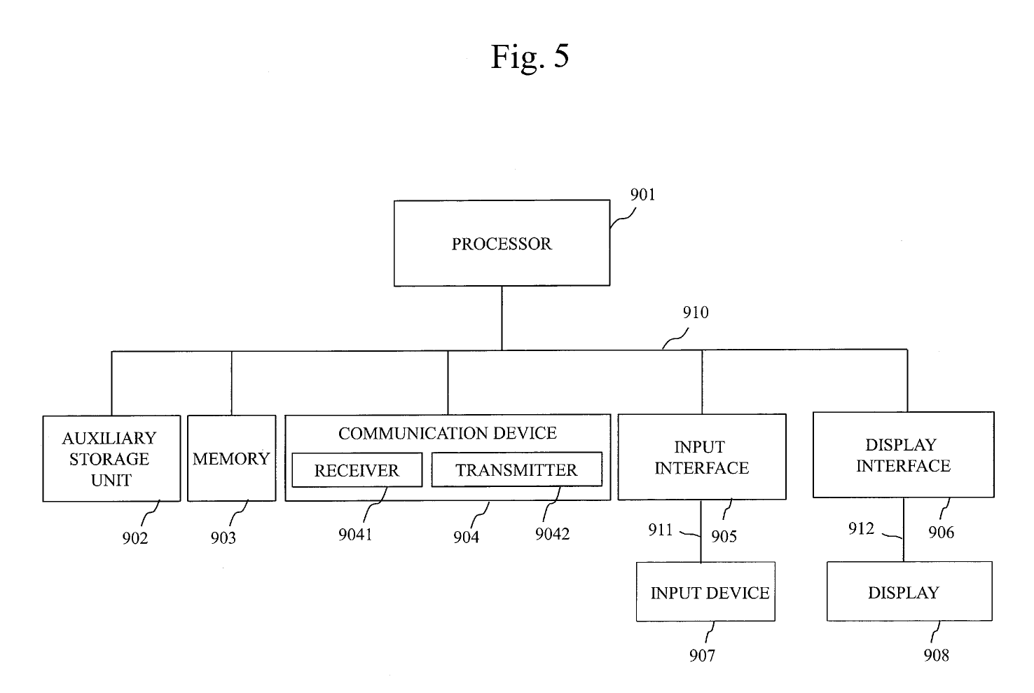

FIG. 5 is a diagram illustrating a hardware configuration example of the simulation apparatus 10 according to the first embodiment.

The simulation apparatus 10 is a computer.

The simulation apparatus 10 is provided with hardware devices such as a processor 901, an auxiliary storage device 902, a memory 903, a communication device 904, an input interface 905, and a display interface 906.

The processor 901 is connected to other hardware devices via a signal line 910 and controls these other hardware devices.

The input interface 905 is connected to an input device 907 via a cable 911.

The display interface 906 is connected to a display 908 via a cable 912.

The processor 901 is an Integrated Circuit (IC) which performs processing. The processor 901 is, for example, a Central Processing Unit (CPU), a Digital Signal Processor (DSP), or a Graphics Processing Unit (GPU).

The auxiliary storage device 902 is, for example, a Read Only Memory (ROM), a flash memory, or a Hard Disk Drive (HDD).

The memory 903 is, for example, a Random Access Memory (RAM).

The communication device 904 includes a receiver 9041 for receiving data and a transmitter 9042 for transmitting data. The communication device 904 is, for example, a communication chip or a Network Interface Card (NIC).

The input interface 905 is a port to which the cable 911 of the input device 907 is connected. The input interface 905 is, for example, a Universal Serial Bus (USB) terminal.

The display interface 906 is a port to which the cable 912 of the display 908 is connected. The display interface 906 is, for example, a USB terminal or a High Definition Multimedia Interface (HDMI) (registered trademark) terminal.

The input device 907 is, for example, a mouse, a keyboard, or a touch panel.

The display 908 is, for example, a Liquid Crystal Display (LCD).

The auxiliary storage device 902 stores a program that realizes functions of the data reception unit 11, the appropriate value calculation unit 12, the simulation unit 13, the setting identifying unit 14, the data transmission unit 15, and the target determination unit 16 described above (the data reception unit 11, the appropriate value calculation unit 12, the simulation unit 13, the setting identifying unit 14, the data transmission unit 15, and the target determination unit 16 will be collectively expressed as “unit” hereinafter).

This program is loaded into the memory 903, read into the processor 901, and executed by the processor 901.

Furthermore, an Operating System (OS) is stored in the auxiliary storage device 902.

Then, at least a part of the OS is loaded into the memory 903, and the processor 901 executes the program that realizes the functions of the “unit” while executing the OS.

In FIG. 5, one processor 901 is illustrated, but the simulation apparatus 10 may be provided with a plurality of processors 901. Then, the plurality of processors 901 may cooperatively execute the program that realizes the functions of the “unit”.

Further, information, data, signal values, and variable values indicating a result of a process of the “unit” are stored in the form of a file in the memory 903, the auxiliary storage device 902, or a register or a cache memory in the processor 901.

Further, the program that realizes the functions of the “unit” is stored in a storage medium such as a magnetic disk, a flexible disk, an optical disk, a compact disk, a Blu-ray (registered trademark) disk, or a DVD.

The “unit” may be provided as “circuitry”. Further, the “unit” may be replaced by a “circuit”, “step”, “procedure”, or “process”. The “circuit” and “circuitry” are each a concept including not only the processor 901, but also other types of processing circuits such as a logic IC, a Gate Array (GA), an Application Specific Integrated Circuit (ASIC), or a Field-Programmable Gate Array (FPGA).

Further, the data reception unit 11 may be realized as the receiver 9041 and the data transmission unit 15 may be realized as the transmitter 9042.

### REFERENCE SIGNS LIST

10: simulation apparatus, 11: data reception unit, 12: appropriate value calculation unit, 13: simulation unit, 14: setting identifying unit, 15: data transmission unit, 16: target determination unit, 20: automation system, 30: network, 40: log storage device, 51: sensor data, 52: productivity data, 53: setting data

1. A simulation apparatus comprising:
processing circuitry to:
perform machine learning from a sensor value detected with a sensor disposed in an automation system and productivity of the automation system at a time when the sensor value is detected, and calculate a sensor value at which the productivity increases, as an appropriate value;
while sequentially changing setting, execute a simulation of an operation of the automation system, and calculate a predicted value of the sensor value for each setting; and
identify the setting in a case where the predicted value calculated is close to the appropriate value calculated.

2. The simulation apparatus according to claim 1,
wherein the processing circuitry performs the machine learning from a plurality of pairs of the sensor value and the productivity of the automation system at a time when the sensor value is detected, the plurality of pairs being sequentially received and accumulated while the automation system is in operation, and calculates the sensor value at which the productivity increases, as the appropriate value.

3. The simulation apparatus according to claim 2,
wherein the processing circuitry determines whether or not the productivity of the automation system in a case where the automation system is operated using the setting identified has become higher than a target value,
wherein when the processing circuitry determines that the productivity has not become higher than the target value, the processing circuitry performs the machine learning using the pairs of the sensor value and the productivity accumulated after the appropriate value is calculated last time, and recalculates the sensor value at which the productivity increases, as the appropriate value, and
wherein the processing circuitry identifies the setting in a case where the predicted value is close to the appropriate value recalculated.

4. The simulation apparatus according to claim 1, comprising
wherein the processing circuitry determines whether or not the productivity of the automation system in a case where the automation system is operated using the setting identified has become higher than a target value,
wherein when the processing circuitry determines that the productivity has not become higher than the target value, the processing circuitry performs the machine learning from the sensor value detected with the sensor disposed at a different position of the automation system and the productivity of the automation system at a time when the sensor value is detected, and recalculates the sensor value at which the productivity increases, as the appropriate value, and
wherein the processing circuitry identifies the setting in a case where the predicted value is close to the appropriate value recalculated.

5. The simulation apparatus according to claim 1,
wherein the processing circuitry determines whether or not the productivity of the automation system in a case where the automation system is operated using the setting identified has become higher than the target value,
wherein when the processing circuitry determines that the productivity has not become higher than the target value, the processing circuitry executes a simulation of an operation of the automation system by another simulation logic, and recalculates a predicted value of the sensor value for said each setting, and
wherein the processing circuitry identifies the setting in a case where the predicted value recalculated is close to the appropriate value.

6. A non-transitory computer readable medium storing a simulation program to cause a computer to execute:
an appropriate value calculation process to perform machine learning from a sensor value detected with a sensor disposed in an automation system and productivity of the automation system at a time when the sensor value is detected, and calculate a sensor value at which the productivity increases, as an appropriate value;
a simulation process to, while sequentially changing setting, execute a simulation of an operation of the automation system, and calculate a predicted value of the sensor value for each setting; and
a setting identifying process to identify the setting in a case where the predicted value calculated by the simulation process is close to the appropriate value calculated by the appropriate value calculation process.
